(19) United States
(12) Patent Application Publication
(10) Pub. No.: US 2012/0259445 A1
(43) Pub. Date: Oct. 11, 2012

(54) METHOD FOR MATCHING ASSISTANT FEATURE TOOLS

(75) Inventors: Kuo Kuei Fu, Guishan Township (TW); Yi Nan Chen, Taipei City (TW); Hsien Wen Liu, Luzhu Township (TW)

(73) Assignee: NANYA TECHNOLOGY CORPORATION, Kueishan (TW)

(21) Appl. No.: 13/080,085

(22) Filed: Apr. 5, 2011

(51) Int. Cl. G06F 19/00

(52) U.S. Cl. 700/97

(57) ABSTRACT

A method for matching assistant feature tools includes the steps of: generating an objective assistant feature according to a specific test layout by a first assistant feature tool; generating a compared assistant feature according to the specific test layout by a second assistant feature tool; and determining whether to accept or reject the second assistant feature tool by comparing the compared assistant feature with the objective assistant feature.

### TECHNICAL FIELD

The present invention relates to a method for matching assistant feature tools, and more particularly, to a method for matching assistant feature tools by comparing assistant features thereof.

### BACKGROUND

In semiconductor manufacturing processes, in order to transfer an integrated circuit layout onto a semiconductor wafer, the integrated circuit layout is first designed and formed as a photomask pattern. The photomask pattern is then proportionally transferred to a photoresist layer positioned on the semiconductor wafer.

As the design pattern of integrated circuit becomes smaller and due to the resolution limit of the optical exposure tool, optical proximity effect can easily occur during the photolithographic process for transferring the photomask pattern with higher density. The optical proximity effect causes deviation defects, such as residue of the assistant feature next to the right-angled main feature, right-angled corner rounding, line end shortening, and line width increasing or decreasing, when transferring the photomask pattern.

To avoid the aforementioned problems of the optical proximity effect, usually, an optical proximity correction (OPC) is applied to the design of a photomask pattern, and assistant features (AF) are added in the design of a photomask pattern so as to prevent the optical proximity effect. Computer aided design (CAD) is used to calculate the optical proximity correction according to the photomask pattern, and then the photomask pattern and assistant features are estimated by a computer, for example.

Assistant feature (AF) plays an important role in optical proximity correction. Different AF placements cause obvious differences in on-wafer performance.

An assistant feature tool for estimating assistant features according to a photomask pattern to prevent the optical proximity effect is very important, but expensive. As an assistant feature tool is good for estimating assistant features, its estimating rule is acceptable and can serve as a reference objective assistant feature tool.

OPC engineers are requested to evaluate new versions or new developed assistant feature tool in order to assure user-friendly operation. However, the same assistant feature rule used in different assistant feature tools might cause different assistant feature placement results due to differences in main logic rules for generating assistant feature.

In the prior art, different assistant feature tools are used to generate assistant features according to a small region cut from a product layout, so as to obtain different assistant feature placement results. However, it is not easy to evaluate the acceptability of a new version or new developed assistant feature tool with an estimating rule different from the reference objective assistant feature tool. Therefore, there is a need for a method for matching assistant feature tools.

### SUMMARY

One aspect of the present invention provides a method for matching assistant feature tools to evaluate a new version or new developed assistant feature tool for user-friendly operation. In one embodiment of the present invention, a method for matching assistant feature tools comprises the steps of: generating an objective assistant feature according to a specific test layout by a first assistant feature tool; generating a compared assistant feature according to the specific test layout by a second assistant feature tool; and determining whether to accept or reject the second assistant feature tool by comparing the compared assistant feature with the objective assistant feature.

The foregoing outlines rather broadly the features of the present invention in order that the detailed description of the invention to follow may be better understood. Additional features of the invention will be described hereinafter and form the subject of the claims of the invention. It should be appreciated by those skilled in the art that the concept and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives of the present invention will become apparent upon reading the following description and upon reference to the accompanying drawings in which:

FIG. 1 is a flow diagram illustrating a method for matching assistant feature tools according to one embodiment of the present invention;

FIGS. 2 to 4 illustrate a method for generating an objective assistant feature according to a specific test layout by a first assistant feature tool according to one embodiment of the present invention;

FIGS. 5 and 6 illustrate a method for generating a compared assistant feature according to the specific test layout generated by a second assistant feature tool according to one embodiment of the present invention; and

FIGS. 7 and 8 illustrate a U-shaped objective assistant feature and an N-shaped objective assistant feature according to one embodiment of the present invention.

### DETAILED DESCRIPTION

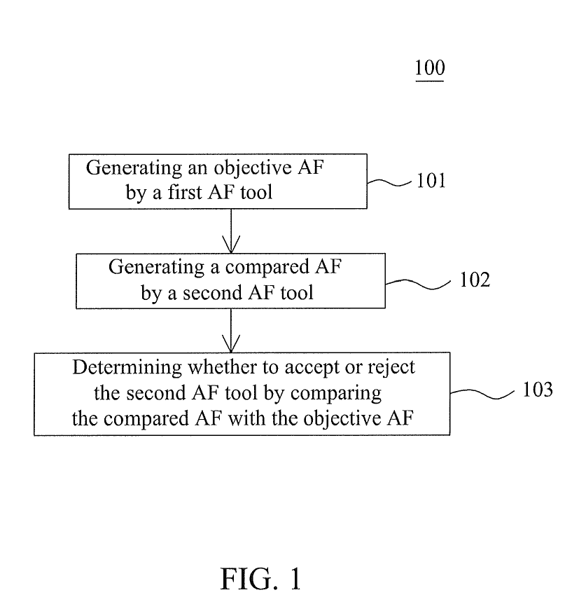

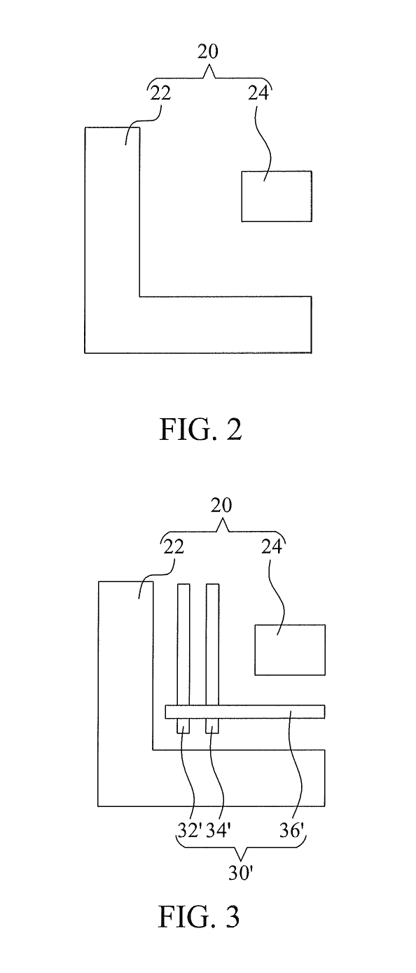

FIG. 1 is a flow diagram illustrating a method for matching assistant feature (AF) tools according to one embodiment of the present invention. FIGS. 2 to 4 illustrate a method for generating an objective assistant feature according to a specific test layout 20 by a first assistant feature tool according to one embodiment of the present invention. Referring to step 101 and FIGS. 2 to 4, in one embodiment of the present invention, an objective assistant feature 30 is generated according to a specific test layout 20 which includes main features 22, 24 (such as a part of an integrated circuit layout, with 1-dimension or 2-dimension patterns, as shown in FIG. 2) by a first assistant feature tool.

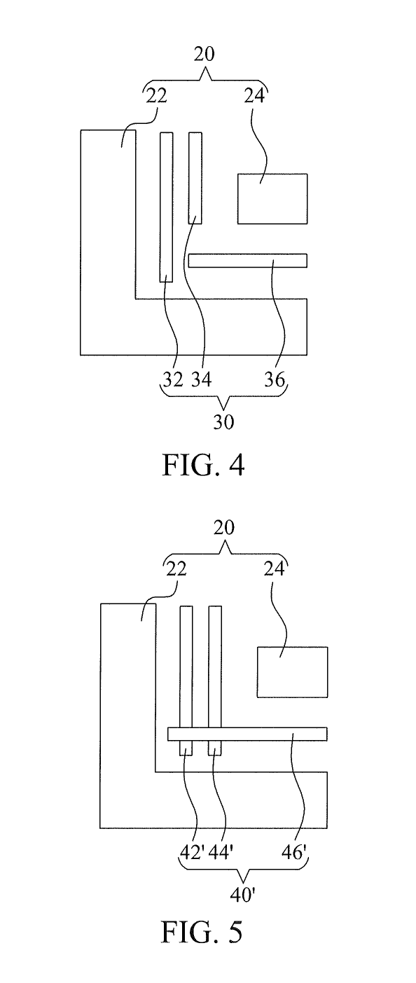

In this embodiment, the step of generating the objective assistant feature comprises the steps of: generating a first initial assistant feature 30′ including first initial patterns 32′, 34′, 36′ according to the specific test layout 20 (as shown in FIG. 4), wherein the first initial patterns 32′, 34′, 36′ at least partly overlay each other; and adjusting the first initial assistant feature 30′ according to a first end adjust rule to form the objective assistant feature 30 (as shown in FIG. 5).

In this embodiment, the objective assistant feature 30 is configured substantially in an L shape and located between two adjacent main features 22, 24. The objective assistant feature 30 may be selected from a serif or a scattering bar, or a combination of a serif and a scattering bar.

As shown in FIG. 3, the first initial assistant feature 30′ includes two vertical bars 32′, 34′ and one horizontal bar 36′ which orthogonally overlays the two vertical bars 32′, 34′. As shown in FIG. 4, the first initial assistant feature 30′ is then modified to remove part of the horizontal bar 34′ and part of the vertical bar 36′, so that the modified vertical bars 32, 34 and the modified horizontal bar 36 do not overlay each other.

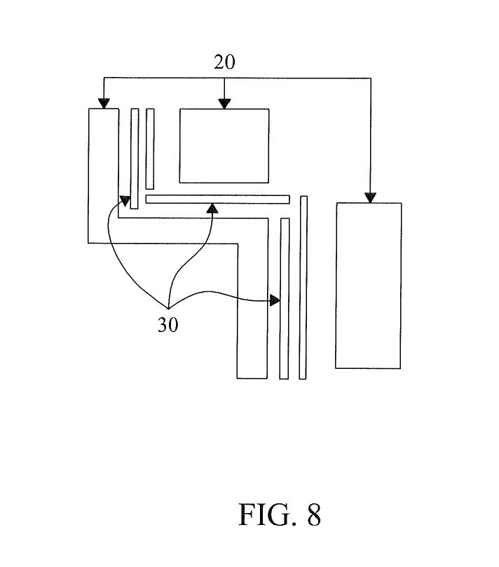

It should be noted that the objective assistant feature 30 may be configured substantially in a U shape or an N shape but is not limited thereto, depending on main features of a specific test layout 20, and the rules for generating the U-shaped or N-shaped objective assistant feature 30 (as shown in FIG. 7 and FIG. 8, respectively) can refer to the generating rule mentioned above.

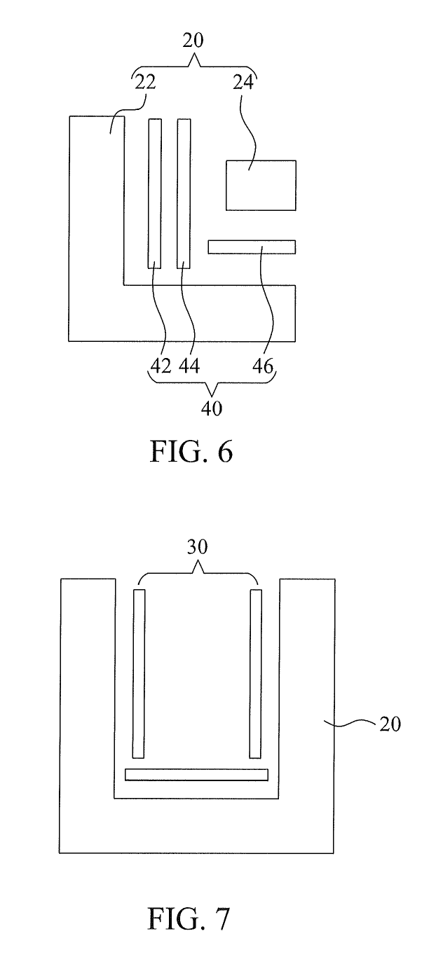

FIGS. 5 and 6 illustrate a method for generating a compared assistant feature 40 according to the specific test layout 20 generated by a second assistant feature tool according to one embodiment of the present invention. Referring to step 102, FIG. 3, and FIGS. 5 to 6, in one embodiment of the present invention, a compared assistant feature 40 is generated according to the specific test layout 20 by a second assistant feature tool. In this embodiment, the step of generating the compared assistant feature 40 comprises the steps of: generating a second initial assistant feature 40′ including second initial patterns 42′, 44′, 46′ according to the specific test layout 20 (as shown in FIG. 5), wherein the second initial patterns 42′, 44′, 46′ at least partly overlay each other; and adjusting the second initial assistant feature 40′ to form the compared assistant feature 40 (as shown in FIG. 6).

As shown in FIG. 5, the second initial assistant feature 40′ includes two vertical bars 42′, 44′ and one horizontal bar 46′ which orthogonally overlays the two vertical bars 42′, 44′. As shown in FIG. 6, the second initial assistant feature 40′ is then modified to remove part of the horizontal bar 46′, so that the modified horizontal bar 46 does not overlay the modified vertical bars 42, 44.

In this embodiment, the second initial assistant feature 40′ is adjusted according to a second end adjust rule which is substantially different from the first end adjust rule. It should be noted that the first assistant feature tool and the second assistant feature tool may be included in the same device or in different devices.

Referring to step 103, the second assistant feature tool is determined as accepted or rejected by comparing the compared assistant feature 40 with the objective assistant feature 30.

For example, the compared assistant feature 40 shown in FIG. 6 is considered as substantially different from the objective assistant feature 30 shown in FIG. 4, and the rule of generating the compared assistant feature 40 should be modified.

In one embodiment of the present invention, the step of modifying the rule of generating the new compared assistant feature can comprise the steps of: generating a modified initial assistant feature including modified initial patterns according to the specific test layout 20, wherein the modified initial patterns at least partly overlay each other; and adjusting the modified initial assistant feature to form the new compared assistant feature, wherein the new compared assistant feature is compared with the objective assistant feature 30 for determining whether to accept or reject the second assistant feature tool.

In the modified rule, the compared assistant feature 40 is then modified (in substantially the same way as illustrated in FIGS. 3 to 4, for example) to generate a new compared assistant feature (substantially the same as the objective assistant feature 30 shown in FIG. 4, for example), so that the new compared assistant feature substantially matches the objective assistant feature 30, and the second assistant feature tool is determined as accepted. However, if no modified rule of generating a new compared assistant feature which substantially matches the objective assistant feature 30 can be found, the second assistant feature tool is rejected.

Although the present invention and its objectives have been described in detail, it should be understood that various changes, substitutions and alterations can be made herein without departing from the spirit and scope of the invention as defined by the appended claims. For example, many of the processes discussed above can be implemented using different methodologies, replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for matching assistant feature tools, comprising the steps of:
generating, using a first device storing a first assistant feature tool, an objective assistant feature to improve the resolution of a specific test layout;
generating, using a second device storing a second assistant feature tool, a compared assistant feature to improve the resolution of the specific test layout; and
determining whether to accept or reject the second device storing the second assistant feature tool by comparing the compared assistant feature with the objective assistant feature.

2. The method for matching assistant feature tools of claim 1, wherein the step of generating the objective assistant feature comprises the steps of:
generating a first initial assistant feature including first initial patterns according to the specific test layout, wherein the first initial patterns at least partly overlay each other; and
adjusting the first initial assistant feature to form the objective assistant feature.

3. The method for matching assistant feature tools of claim 2, wherein the first initial assistant feature is adjusted according to a first end adjust rule.

4. The method for matching assistant feature tools of claim 1, wherein the step of generating the compared assistant feature comprises the steps of:
generating a second initial assistant feature including second initial patterns according to the specific test layout, wherein the second initial patterns at least partly overlay each other; and
adjusting the second initial assistant feature to form the compared assistant feature.

5. The method for matching assistant feature tools of claim 4, wherein the second initial assistant feature is adjusted according to a second end adjust rule which is substantially different from the first end adjust rule.

6. The method for matching assistant feature tools of claim 1, wherein the second assistant feature tool is determined as accepted if the compared assistant feature substantially matches the objective assistant feature; otherwise, the rule of generating the compared assistant feature is modified to generate a new compared assistant feature.

7. The method for matching assistant feature tools of claim 6, wherein the step of modifying the rule of generating the new compared assistant feature comprises the steps of:
generating a modified initial assistant feature including modified initial patterns according to the specific test layout, wherein the modified initial patterns at least partly overlay each other; and
adjusting the modified initial assistant feature to form the new compared assistant feature, wherein the new compared assistant feature is compared with the objective assistant feature for determining whether to accept or reject the second assistant feature tool.

8. The method for matching assistant feature tools of claim 7, wherein the second assistant feature tool is determined as accepted if the new compared assistant feature substantially matches the objective assistant feature; otherwise, the second assistant feature tool is determined as rejected.

9. The method for matching assistant feature tools of claim 1, wherein the first assistant feature tool and the second assistant feature tool are included in the same device.

10. The method for matching assistant feature tools of claim 1, wherein the first assistant feature tool and the second assistant feature tool are included in different devices.

11. The method for matching assistant feature tools of claim 1, wherein the objective assistant feature is configured substantially in an L shape, a U shape, or an N shape.

12. The method for matching assistant feature tools of claim 1, wherein the specific test layout includes main features and the objective assistant feature is located between two adjacent main features.

13. The method for matching assistant feature tools of claim 12, wherein the objective assistant feature is selected from a serif or a scattering bar, or a combination of a serif and a scattering bar.
